(19) United States
(12) Patent Application Publication
(10) Pub. No.: US 2026/0204885 A1
(43) Pub. Date: Jul. 16, 2026

(54) WIRE HARNESS ROUTING STRUCTURE AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Daichi FUKUSHIMA, Osaka (JP); Yasuyuki YAMAMOTO, Osaka (JP); Ryohei KAKAMI, Osaka (JP)

(21) Appl. No.: 19/136,889

(22) PCT Filed: Dec. 5, 2023
(86) PCT No.: PCT/JP2023/043504

§ 371 Date: Jun. 9, 2025

(30) Foreign Application Priority Data
Dec. 13, 2022 (JP) 2022-198358

(51) Int. Cl. H02G 3/32; B60R 16/02; H02G 11/00

(52) U.S. Cl. CPC H02G 3/32; B60R 16/0215; H02G 11/00

(57) ABSTRACT

A wire harness routing structure is a wire harness routing structure for a plate-like routing target member that includes a first surface and a second surface, including: a wire harness including a base and a wiring member routed to the base; and a fixing portion configured to fix the base to the routing target member. The base includes a first planar part configured to cover the first surface, a second planar part configured to cover the second surface, and a connecting part configured to connect the first planar part and the second planar part to be bendable relative to each other on one side of the routing target member, and the wiring member includes a first wiring member held by the first planar part and a second wiring member held by the second planar part.

### TECHNICAL FIELD

The present disclosure relates to a wire harness routing structure and a wire harness.

### BACKGROUND

Patent Document 1 discloses a method of routing a wire harness to a power seat. The routing method comprises mounting electrical components to be equipped in a power seat on a board in advance, electrically connecting a wire harness to the electrical components and routing the wire harness to the board in advance, and attaching the board to which the wire harness is routed to the power seat.

### PRIOR ART DOCUMENT

### Patent Document

Patent Document 1: JP 2010-018106 A

### SUMMARY OF THE INVENTION

### Problems to be Solved

It is desirable to easily route a wire harness on both surfaces of a plate-like routing target member such as a framework of a seat.

The present disclosure therefore has an object of enabling a wire harness to be easily routed on both surfaces of a plate-like routing target member.

### Means to Solve the Problem

A wire harness routing structure according to the present disclosure is a wire harness routing structure for a plate-like routing target member that includes a first surface and a second surface, the wire harness routing structure including: a wire harness including a base and a wiring member routed to the base; and a fixing portion configured to fix the base to the routing target member, wherein the base includes a first planar part configured to cover the first surface, a second planar part configured to cover the second surface, and a connecting part configured to connect the first planar part and the second planar part to be bendable relative to each other on one side of the routing target member, and the wiring member includes a first wiring member held by the first planar part and a second wiring member held by the second planar part.

### Effect of the Invention

According to the present disclosure, it is possible to easily route a wire harness on both surfaces of a plate-like routing target member.

### BRIEF DESCRIPTION OF THE DRAWINGS

FIG. 1 is a schematic plan view showing a wire harness routing structure according to a first embodiment.

FIG. 2 is a schematic perspective view showing the wire harness routing structure according to the first embodiment.

FIG. 3 is an explanatory diagram showing how a wire harness is attached to a routing target member.

FIG. 4 is an explanatory diagram showing how the wire harness is attached to the routing target member.

FIG. 5 is a side view showing a modification of the wire harness.

FIG. 6 is a side view showing a first modification of a fixing portion.

FIG. 7 is a side view showing a second modification of the fixing portion.

FIG. 8 is a side view showing a third modification of the fixing portion.

FIG. 9 is a side view showing a first modification of a holding portion for a wiring member.

FIG. 10 is a side view showing a second modification of the holding portion for the wiring member.

FIG. 11 is a side view showing a third modification of the holding portion for the wiring member.

### DETAILED DESCRIPTION TO EXECUTE THE INVENTION

### Description of Embodiments of the Present Disclosure

First, embodiments of the present disclosure will be listed and described.

A wire harness routing structure according to the present disclosure is the following.
(1) A wire harness routing structure for a plate-like routing target member that includes a first surface and a second surface, including: a wire harness including a base and a wiring member routed to the base; and a fixing portion configured to fix the base to the routing target member, wherein the base includes a first planar part configured to cover the first surface, a second planar part configured to cover the second surface, and a connecting part configured to connect the first planar part and the second planar part to be bendable relative to each other on one side of the routing target member, and the wiring member includes a first wiring member held by the first planar part and a second wiring member held by the second planar part.
With the wire harness routing structure according to (1), the wire harness can be easily routed on both surfaces of the plate-like routing target member by attaching, to the plate-like routing target member, the base to which the first wiring member and the second wiring member are routed. Since the base includes the connecting part, it is easier to route the first wiring member on the first planar part and the second wiring member on the first planar part than in the case where the first planar part and the second planar part are connected so as not to bend.
(2) In the wire harness routing structure according to (1), both the first planar part and the second planar part may have a rigidity that makes the first planar part and the second planar part more difficult to bend than the connecting part. Thus, both the first planar part and the second planar part are high-rigidity members and can be easily placed facing the plate-like routing target member.
(3) In the wire harness routing structure according to (2), the base may be a single rigid plate material from the first planar part to the second planar part, and the connecting part may have a hinge shape that is easier to bend than the first planar part and the second planar part. This can prevent an increase in the number of parts of the base.
(4) In the wire harness routing structure according to (1), one of the first planar part and the second planar part may have a rigidity that makes the planar part more difficult to bend than the connecting part. Thus, one of the first planar part and the second planar part is a high-rigidity member and can be easily placed facing the routing target member.
(5) In the wire harness routing structure according to any one of (1) to (4), the fixing portion may be configured to fix each of the first planar part and the second planar part to the routing target member. As a result, each of the first planar part and the second planar part can be firmly fixed to the routing target member.
(6) In the wire harness routing structure according to any one of (1) to (4), the fixing portion may be configured to fix the first planar part and the second planar part on an opposite side to the connecting part. Thus, the base is fixed to the routing target member by being maintained in a state of surrounding the routing target member.
(7) In the wire harness routing structure according to any one of (1) to (6), the first wiring member may extend to pass through the base, and an end of the second wiring member may be located on the base. This makes it easy to separately route, to the routing target member, the first wiring member that passes through the routing target member and the second wiring member that is connected to equipment or the like at the position of the routing target member.
(8) In the wire harness routing structure according to any one of (1) to (7), the wire harness may include a branch portion that branches from a trunk portion into the first wiring member and the second wiring member, and a distance between the base and the branch portion may be shorter than a length of the first wiring member extending on the first planar part. This makes it easy to position the branch portion between the first wiring member and the second wiring member near the base.
(9) In the wire harness routing structure according to any one of (1) to (8), the routing target member may be a part of a framework of a seat of a vehicle. Thus, the wire harness can be easily routed to the vehicle seat.
(10) A wire harness according to the present disclosure is a wire harness configured to be routed to a plate-like routing target member that includes a first surface and a second surface, the wire harness including: a base including a first planar part configured to cover the first surface, a second planar part configured to cover the second surface, and a connecting part configured to connect the first planar part and the second planar part to be bendable relative to each other; and a wiring member including a first wiring member held by the first planar part and a second wiring member held by the second planar part.

The wire harness according to (10) can be easily routed on both surfaces of the plate-like routing target member by attaching, to the plate-like routing target member, the base to which the first wiring member and the second wiring member are routed. Since the base includes the connecting part, it is easier to route the first wiring member on the first planar part and the second wiring member on the first planar part than in the case where the first planar part and the second planar part are connected so as not to bend.

### Details of Embodiments of the Present Disclosure

Specific examples of a wire harness routing structure according to the present disclosure will be described below with reference to the drawings. The present disclosure is not limited to these examples, but is defined by the claims and intended to include all modifications within the meaning and scope equivalent to the claims.

### First Embodiment

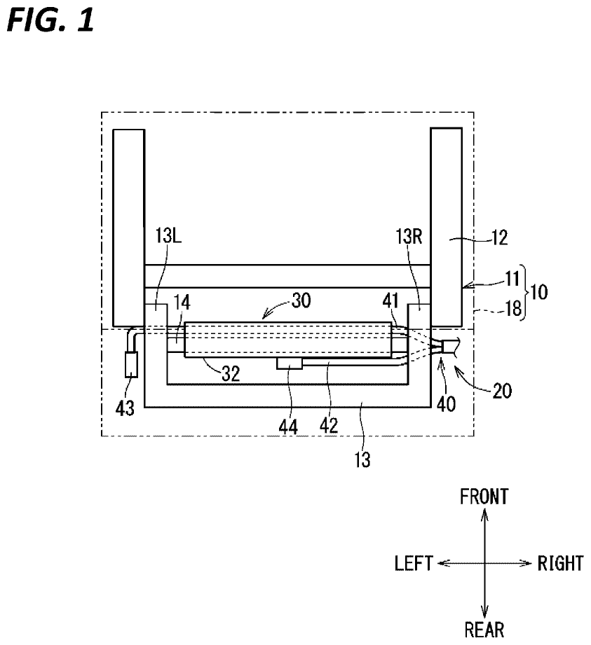

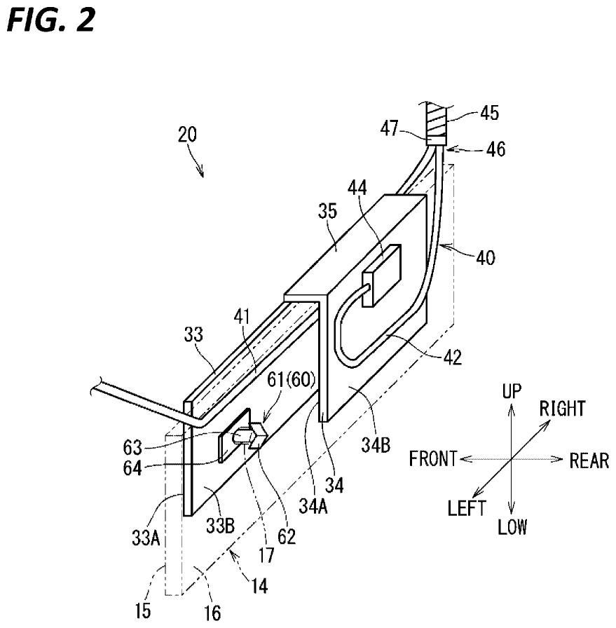

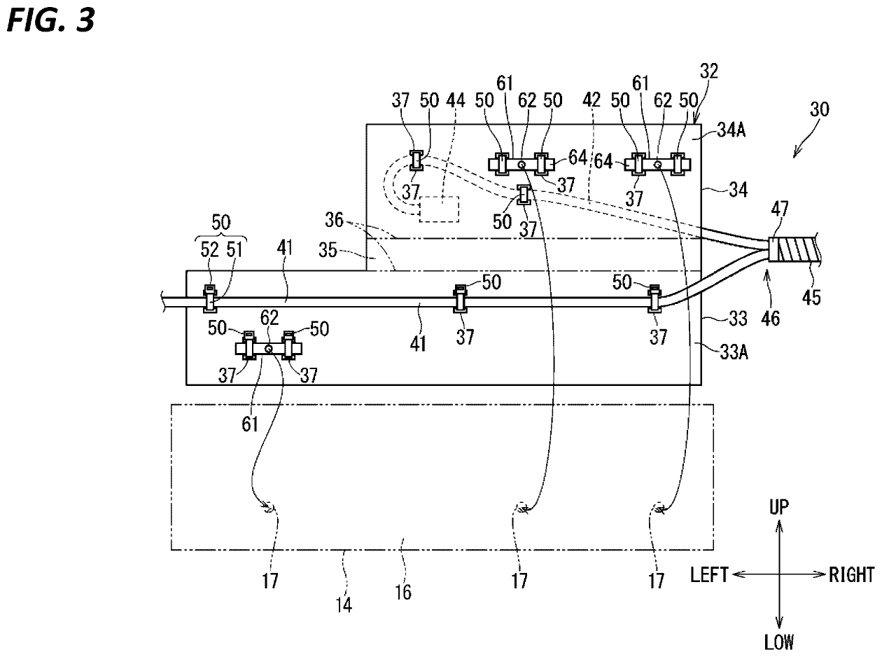

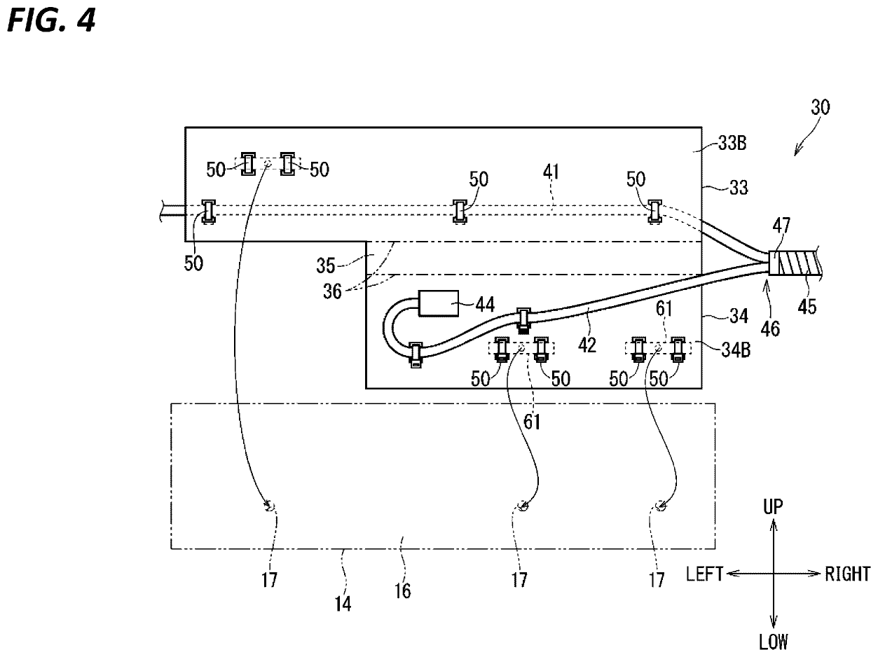

A wire harness routing structure according to a first embodiment will be described below. FIG. 1 is a schematic plan view showing a wire harness routing structure 20 according to the first embodiment. FIG. 2 is a schematic perspective view showing the wire harness routing structure 20 according to the first embodiment. FIG. 3 and FIG. 4 are explanatory diagrams showing how a wire harness 30 is attached to a routing target member 14. FIG. 3 shows a front view of the wire harness 30 before being bent, assuming that a first planar part 33 is attached to the routing target member 14 before a second planar part 34. FIG. 4 shows a rear view of the wire harness 30 before being bent, assuming that the second planar part 34 is attached to the routing target member 14 before the first planar part 33. The front-rear direction (FRONT, REAR), left-right direction (LEFT, RIGHT), and up-low (i.e. up-down) direction (UP, LOW) shown in each drawing correspond to the front-rear direction, left-right direction, and up-low direction in a vehicle.

The wire harness routing structure 20 routes a wiring member 40 on both a first surface 15 and a second surface 16 of a plate-like routing target member 14. First, the routing target member 14 will be described.

It is assumed here that the routing target member 14 is a part of a framework 11 of a seat 10 of a vehicle. The seat 10 includes the framework 11 and a cushion portion 18. The framework 11 includes a lower frame 12 that supports part of the cushion portion 18 serving as a seating surface, and an upper frame 13 that supports part of the cushion portion 18 serving as a backrest. The lower frame 12 is supported on a floor. The lower frame 12 may be supported slidably on the floor via a slide rail, or supported non-slidably. The upper frame 13 includes a left frame part 13L, a right frame part 13R, and a connecting frame part 14, for example. The left frame part 13L and the right frame part 13R extend from the lower frame 12 in the height direction of the backrest part on the left and right sides of the seat 10. The connecting frame part 14 extends in the left-right direction to connect the left frame part 13L and the right frame part 13R, at a position close to the lower frame 12. Here, the connecting frame part 14 is the routing target member 14.

The routing target member 14 is, for example, a rectangular plate-like member. The main surface of the routing target member 14 extends in the left-right direction and in the height direction of the backrest part. The height direction of the backrest part is the direction in which the backrest part extends from the seating surface part. The backrest part is rotatable relative to the seating surface part. The height direction of the backrest part may be inclined relative to the up-low direction. The direction connecting the front and rear surfaces of the backrest part is the thickness direction of the routing target member 14. In the routing target member 14, the surface located on the front side of the backrest part is the first surface 15, and the surface located on the rear side of the backrest part is the second surface 16. The routing target member 14 is formed in a rectangular shape. The long sides of the routing target member 14 extend in the left-right direction, and the short sides of the routing target member 14 extend in the height direction of the backrest part.

Here, the routing target member 14 is a rigid member made of metal. The routing target member 14 may be made of resin. The routing target member 14 has a through hole 17 extending from the first surface 15 to the second surface 16. The first surface 15 and the second surface 16 may be flat surfaces except for the part where the through hole 17 is formed. The first surface 15 and the second surface 16 may include an uneven part for increasing the rigidity of the routing target member 14, for example. The uneven part may be a rib or a part where the plate material is bent in the thickness direction.

The routing target member 14 is not limited to the above. The routing target member 14 is any plate-like member that is placed in a vehicle and has both surfaces on which a wiring member is to be routed. It is preferable that there is a space on one side of the routing target member 14 in which a connecting part 35 of a base 32 described later can be placed.

The wire harness routing structure 20 includes a wire harness 30 and a fixing portion 60. The wire harness 30 includes a base 32 and a wiring member 40 routed to the base 32. The fixing portion 60 fixes the wire harness 30 to the routing target member 14.

The base 32 includes a first planar part 33 that covers the first surface 15, a second planar part 34 that covers the second surface 16, and a connecting part 35 that connects the first planar part 33 and the second planar part 34. The first planar part 33 has a first inner surface 33A facing the routing target member 14 and a first outer surface 33B opposite the first inner surface 33A. The second planar part 34 has a second inner surface 34A facing the routing target member 14 and a second outer surface 34B opposite the second inner surface 34A. The first inner surface 33A and the second outer surface 34B face the rear of the vehicle, and the first outer surface 33B and the second inner surface 34A face the front of the vehicle. The connecting part 35 connects the first planar part 33 and the second planar part 34 to be bendable relative to each other on one side of the routing target member 14. Here, both the first planar part 33 and the second planar part 34 have a rigidity that makes them more difficult to bend than the connecting part 35.

The base 32 is a single rigid plate material 132A from the first planar part 33 to the second planar part 34. The first planar part 33 and the second planar part 34 are difficult to bend due to the rigidity of the rigid plate material 132A. The connecting part 35 is formed to have a hinge-shaped portion 36 that is easier to bend than the first planar part 33 and the second planar part 34. The hinge-shaped portion 36 partially reduces the rigidity of the rigid plate material 132A. For example, the hinge-shaped portion 36 may be formed by making a slit in the rigid plate material 132A or by partially cutting out part of the rigid member. Alternatively, the rigid plate material 132A may be formed to have a thin part in advance, which serves as the hinge-shaped portion 36.

Here, two hinge-shaped portions 36 are provided. One hinge-shaped portion 36 is connected to the first planar part 33, and the other hinge-shaped portion 36 is connected to the second planar part 34. The two hinge-shaped portions 36 and the part between them form the connecting portion. The number of hinge-shaped portions 36 may be one. In this case, the single hinge-shaped portion 36 is the connecting portion. The number of hinge-shaped portions 36 may be three or more.

The base 32 is made of resin or metal. For example, the base 32 may be a plate material having a hollow structure such as corrugated plastic, or a solid plate material having no hollow structure.

The wiring member 40 supplies power to the equipment of the seat 10 and transmits signals between the equipment of the seat 10 and the equipment of the vehicle body. The wiring member 40 is a transmission member that transmits electricity or light, such as an electric wire or an optical fiber cable. The wiring member 40 includes a first wiring member 41 held by the first planar part 33 and a second wiring member 42 held by the second planar part 34.

The ends of the first wiring member 41 and the second wiring member 42 on the seat 10 side are provided with a seat 10 side connector or the like to be connected to the equipment of the seat 10. The ends of the first wiring member 41 and the second wiring member 42 on the vehicle body side are provided with a connector or the like to be connected to the equipment of the vehicle body.

The first wiring member 41 extends to pass through the base 32. The first wiring member 41 extends on the first planar part 33 from outside the first planar part 33 on one side of the base 32 in the left-right direction, and extends out of the base 32 on the other side of the base 32 in the left-right direction. As shown in FIG. 1, a first connector 43, which is a seat side connector of the first wiring member 41, is not located on the base 32. The path and fixed position of the first wiring member 41 on the first planar part 33 are not particularly limited and can be set as appropriate. The end of the first wiring member 41 may be located on the base 32.

The end of the second wiring member 42 is located on the base 32. The second wiring member 42 extends on the second planar part 34 from outside the second planar part 34 on one side of the base 32 in the left-right direction. As shown in FIG. 1, a second connector 44, which is a seat side connector of the second wiring member 42, is located on the base 32. The second connector 44 may or may not be fixed to the second planar part 34. Here, the second planar part 34 is shorter than the first planar part 33 in the left-right direction. The left end of the second planar part 34 opposite the below-described branch portion 46 side is located closer to the branch portion 46 (right side) than the left end of the first planar part 33. The path and fixed position of the second wiring member 42 on the second planar part 34 are not particularly limited and can be set as appropriate. The second wiring member 42 may extend to pass through the base 32.

The wire harness 30 includes a branch portion 46 that branches from a trunk portion 45 into the first wiring member 41 and the second wiring member 42. In the trunk portion 45, the first wiring member 41 and the second wiring member 42 are held together by an exterior member. For example, the exterior member may be a binding member such as adhesive tape 47 or a cable tie 50, a protective tube or protector, or a sheath.

The branch portion 46 may be located near the base 32. For example, the distance between the base 32 and the branch portion 46 may be shorter than the length of the first wiring member 41 extending on the first planar part 33. For example, the distance between the base 32 and the branch portion 46 may be shorter than the length of the second wiring member 42 extending on the second planar part 34.

The first wiring member 41 is not routed on the first outer surface 33B but routed on the first inner surface 33A. The second wiring member 42 is not routed on the second inner surface 34A but routed on the second outer surface 34B. Thus, one of the first wiring member 41 and the second wiring member 42 is routed on the inner surface of the base 32 and the other of the first wiring member 41 and the second wiring member 42 is routed on the outer surface of the base 32. The first wiring member 41 may be routed on the first outer surface 33B and the second wiring member 42 routed on the second inner surface 34A.

The first wiring member 41 and the second wiring member 42 may both be routed on the outer surface of the base 32. The first wiring member 41 and the second wiring member 42 may both be routed on the inner surface of the base 32. The first wiring member 41 may be routed on either the first inner surface 33A or the first outer surface 33B. The first wiring member 41 may be routed on both the first inner surface 33A and the first outer surface 33B. The second wiring member 42 may be routed on either the second inner surface 34A or the second outer surface 34B. The second wiring member 42 may be routed on both the second inner surface 34A and the second outer surface 34B.

The holding structure of the base 32 and the wiring member 40 is not particularly limited and can be set as appropriate. Here, the wiring member 40 is held on the base 32 by cable ties 50. Each cable tie 50 includes a band portion 51 and a band fixing portion 52. One pair of tie insertion holes 37 are formed in the base 32 for the holding portion by each cable tie 50. The wiring member 40 is placed between the pair of tie insertion holes 37. The band fixing portion 52 fixes the band portion 51 in a state in which the band portion 51 wraps around the wiring member 40 and the part of the base 32 between the pair of tie insertion holes 37. The band fixing portion 52 may be located on the inner surface or the outer surface of the base 32.

The fixing portion 60 fixes the base 32 to the routing target member 14. The structure of the fixing portion 60 is not particularly limited as long as it can fix the base 32 to the routing target member 14, and can be set as appropriate. The number and positions of the fixing portions 60 are not particularly limited and can be set as appropriate. Here, the fixing portion 60 fixes each of the first planar part 33 and the second planar part 34 to the routing target member 14. A clip 61 is provided here as the fixing portion 60. The clip 61 includes a locking portion 62, a pillar portion 63, and a plate portion 64. The pillar portion 63 protrudes from the main surface of the plate portion 64. The locking portion 62 protrudes from the tip of the pillar portion 63 toward the plate portion 64. The plate portion 64 is placed on the inner surface of the base 32, and a cable tie 50 is wound around the plate portion 64 and the base 32 to fix the clip 61 to the base 32. As a result of the plate portion 64 being in contact with the inner surface of the base 32, a state in which the pillar portion 63 protrudes in the normal direction of the inner surface of the base 32 can be obtained easily.

In the case where the base 32 is a rigid member, the clip 61 may be formed integrally with the base 32. In this case, the plate portion 64 of the clip 61 may be omitted, with the pillar portion 63 and the locking portion 62 protruding from the base 32.

### Effects, Etc.

With the wire harness routing structure 20 having the above-described structure, the wire harness 30 can be easily routed on both surfaces of the plate-like routing target member 14 by attaching, to the plate-like routing target member 14, the base 32 to which the first wiring member 41 and the second wiring member 42 are routed. Since the base 32 includes the connecting part 35, it is easier to route the first wiring member 41 on the first planar part 33 and the second wiring member 42 on the first planar part 33 than in the case where the first planar part 33 and the second planar part 34 are connected so as not to bend.

The procedure of fixing the wire harness 30 to the routing target member 14 is not particularly limited and can be set as appropriate. For example, as shown in FIG. 3, the first planar part 33 of the wire harness 30 may be fixed to the first surface 15 first, and then the second planar part 34 of the wire harness 30 may be fixed to the second surface 16. For example, as shown in FIG. 4, the second planar part 34 of the wire harness 30 may be fixed to the second surface 16 first, and then the first planar part 33 of the wire harness 30 may be fixed to the first surface 15. The connecting part 35 may be bent after one of the planar parts is fixed. The first planar part 33 and the second planar part 34 may be fixed to the routing target member 14 with the connecting part 35 in a bent state and the first planar part 33 and the second planar part 34 facing the routing target member 14.

Both the first planar part 33 and the second planar part 34 have a rigidity that makes them more difficult to bend than the connecting part 35. Thus, both the first planar part 33 and the second planar part 34 are high-rigidity members and can be easily placed facing the plate-like routing target member 14.

The base 32 is a single rigid plate material 132A from the first planar part 33 to the second planar part 34, and the connecting part 35 is formed with a hinge-shaped portion 36 that is easier to bend than the first planar part 33 and the second planar part 34. This can prevent an increase in the number of parts of the base 32.

The fixing portion 60 fixes each of the first planar part 33 and the second planar part 34 to the routing target member 14. Hence, each of the first planar part 33 and the second planar part 34 can be firmly fixed to the routing target member 14.

The first wiring member 41 extends to pass through the base 32, and an end of the second wiring member 42 is located on the base 32. This makes it easy to separately route, to the routing target member 14, the first wiring member 41 that passes through the routing target member 14 and the second wiring member 42 that is connected to equipment or the like at the position of the routing target member 14.

The wire harness 30 includes a branch portion 46 that branches from a trunk portion 45 into the first wiring member 41 and the second wiring member 42, and the distance between the base 32 and the branch portion 46 is shorter than the length of the first wiring member 41 extending on the first planar part 33. This makes it easy to position the branch portion 46 between the first wiring member 41 and the second wiring member 42 near the base 32.

The routing target member 14 is a part of a framework 11 of a seat 10 of a vehicle. Thus, the wire harness 30 can be easily routed to the seat 10 of the vehicle.

### Supplementary Note

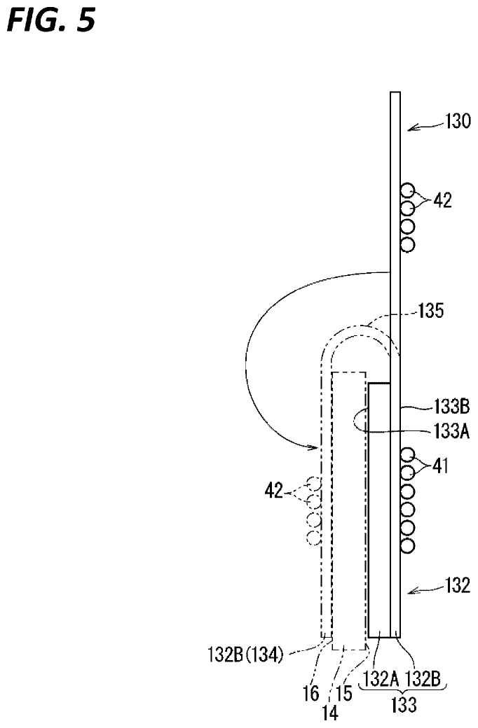

FIG. 5 is a side view showing a modification of the wire harness 30.

In a wire harness 130 according to the modification shown in FIG. 5, one of a first planar part 133 and a second planar part 134 has a rigidity that makes it more difficult to bend than the connecting part 35. Thus, one of the first planar part 133 and the second planar part 134 is a high-rigidity member and can be easily placed facing the routing target member 14. In the case where one of the first planar part 133 and the second planar part 134 is a high-rigidity member as in the wire harness 130, it is preferable to fix the high-rigidity member to the routing target member 14 first.

A base 132 in the wire harness 130 includes a rigid plate material 132A and a flexible sheet 132B. The rigid plate material 132A is provided only in one of the first planar part 133 and the second planar part 134. In the example shown in FIG. 5, the rigid plate material 132A is provided only in the first planar part 33. The rigid plate material 132A may be provided only in the second planar part 34. The flexible sheet 132B is provided from the first planar part 133 to the second planar part 134. The flexible sheet 132B is provided to entirely cover the rigid plate material 132A. The flexible sheet 132B may be provided to cover only part of the rigid plate material 132A including the edge on the connecting part 135 side.

The first planar part 133 includes the rigid plate material 132A and the flexible sheet 132B. The rigid plate material 132A and the flexible sheet 132B are fixed to each other. The fixing method is not particularly limited, and the rigid plate material 132A and the flexible sheet 132B may be attached by fusion or adhesive or clipped together, for example. The second planar part 134 includes the flexible sheet 132B but does not include the rigid plate material 132A. The connecting part 135 includes the flexible sheet 132B but does not include the rigid plate material 132A. Since the flexible sheet 132B forms the connecting part 135, the connecting part 135 is bendable at any position between the first planar part 133 and the second planar part 134.

The first wiring member 41 and the second wiring member 42 are each held on the flexible sheet 132B. The holding structure between the flexible sheet 132B and each of the wiring members 41 and 42 is not particularly limited and can be set as appropriate. For example, the flexible sheet 132B and each of the wiring members 41 and 42 may be fused, or bonded by an adhesive or the like.

In the first planar part 133 including the rigid plate material 132A and the flexible sheet 132B, the rigid plate material 132A is provided on the inner surface of the flexible sheet 132B. The rigid plate material 132A forms a first inner surface 133A of the first planar part 133, and the flexible sheet 132B forms a first outer surface 133B of the first planar part 133. The rigid plate material 132A may be provided on the outer surface of the flexible sheet 132B. Here, the first wiring member 41 is provided on the outer surface of the flexible sheet 132B. The first wiring member 41 may be provided on the inner surface of the flexible sheet 132B. Here, the flexible sheet 132B is located between the first wiring member 41 and the rigid plate material 132A. The first wiring member 41 may be located between the flexible sheet 132B and the rigid plate material 132A.

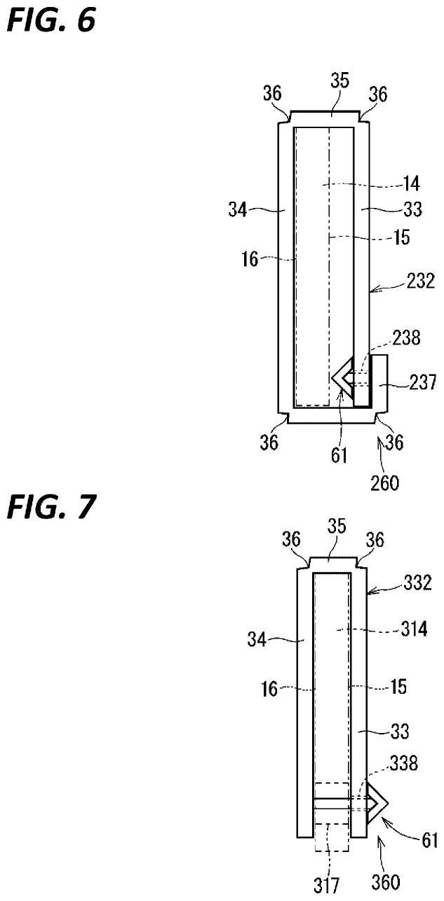

FIG. 6 is a side view showing a first modification of the fixing portion 60.

A fixing portion 260 according to the first modification shown in FIG. 6 fixes the first planar part 33 and the second planar part 34 on the opposite side to the connecting part 35. Thus, the base 32 is fixed to the routing target member 14 by being maintained in a state of surrounding the routing target member 14.

In the example shown in FIG. 6, the base 232 surrounds the entire routing target member 14. Specifically, the base 232 includes a fixing piece 237 extending from one of the first planar part 33 and the second planar part 34 to the opposite side to the connecting part 35. The fixing piece 237 is provided with a clip 61. The clip 61 engages with a locking hole 238 formed in the other of the first planar part 33 and the second planar part 34. The clip 61 may pass through the other of the first planar part 33 and the second planar part 34 and be fixed to the routing target member 14. The clip 61 provided on the other of the first planar part 33 and the second planar part 34 may engage with a locking hole in the fixing piece 237.

FIG. 7 is a side view showing a second modification of the fixing portion 60.

A fixing portion 360 according to the second modification also fixes the first planar part 33 and the second planar part 34 on the opposite side to the connecting part 35. Thus, a base 332 is fixed to a routing target member 314 by being maintained in a state of surrounding the routing target member 314.

In the example shown in FIG. 7, the base 332 does not surround the entire routing target member 314 but surrounds part of the routing target member 314, as in the first embodiment. Specifically, a through hole 317 in the routing target member 314 is larger than the through hole 17 with which a clip 61 engages so that the clip 61 can easily pass through the through hole 317. In the base 332, a clip 61 is provided on one of the first planar part 33 and the second planar part 34, and a locking hole 338 is formed in the other of the first planar part 33 and the second planar part 34. The locking hole 338 is smaller than the through hole 17. The clip 61 passes through the through hole 317 and the locking hole 338 and engages with the periphery of the locking hole 338.

In the case where the clip 61 engages with the base 332 as in the example shown in FIG. 6 or FIG. 7, the part of the base 332 with which the clip 61 engages is preferably a rigid member like the base 32 or the rigid plate material 132A.

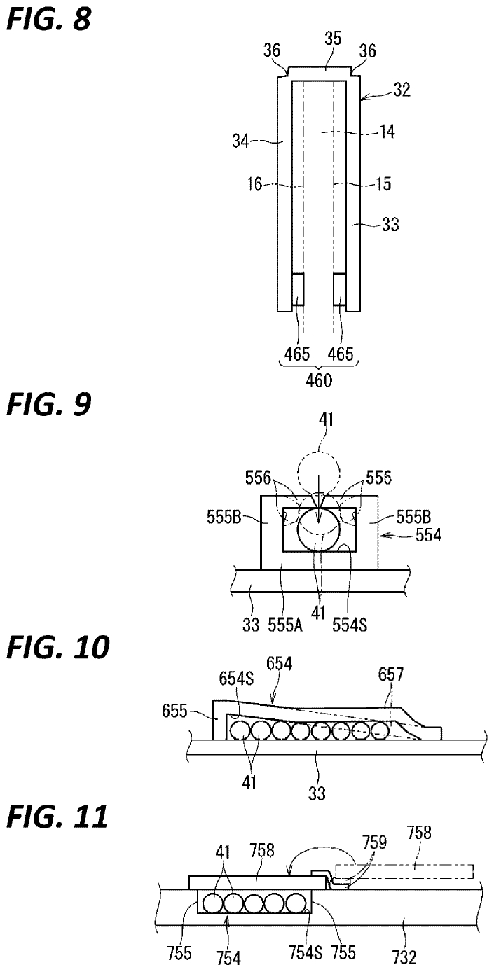

FIG. 8 is a side view showing a third modification of the fixing portion 60.

A fixing portion 460 according to the third modification fixes the base 32 to the routing target member 14 using another member instead of the clip 61. Here, the fixing portion 60 includes a bonding portion 465. The bonding portion 465 is provided between the first planar part 33 and the first surface 15 and between the second planar part 34 and the second surface 16.

The bonding portion 465 is an adhesive. The bonding portion 465 may be a pressure-sensitive adhesive. The adhesive is a hot melt adhesive. The adhesive may be a moisture-curing adhesive or the like. The hot melt adhesive typically exhibits adhesiveness by softening when heated. The heating means may be electromagnetic induction heating. In this case, in a state in which the hot melt adhesive is in contact with the routing target member 14 made of metal, the routing target member 14 may be subjected to electromagnetic induction heating to soften the hot melt adhesive by heat transfer from the routing target member 14.

FIG. 9 is a side view showing a first modification of the holding portion for the wiring member 40.

The holding portion according to the first modification includes a storage space forming portion 554 that forms a storage space 554S in the base 32. While an example of applying the holding portion to the structure in which the first wiring member 41 is held by the first planar part 33 is described here, the holding portion may also be applied to the structure in which the second wiring member 42 is held by the second planar part 34. The same applies to the below-described second and third modifications of the holding portion. Here, the storage space forming portion 554 includes a bottom wall 555A fixed to the first planar part 33, a pair of side walls 555B protruding from the bottom wall 55A, and elastic retaining pieces 556 protruding from the tips of the pair of side walls 555B. An opening through which the first wiring member 41 passes is formed between the pair of elastic retaining pieces 556. The elastic retaining pieces 556 are elastically deformable so as to widen the opening when pushed by the first wiring member 41. When the first wiring member 41 passes through the opening and is stored in the storage space 554S, the elastic retaining pieces 556 elastically return to their original position and the first wiring member 41 is maintained in a state of being stored in the storage space 554S. A plurality of first wiring members 41 may be stored in the storage space 554S in a bundled state. A plurality of first wiring members 41 may be stored in the storage space 554S in a loose state without being bundled. The same applies to storing a plurality of first wiring members 41 in the below-described storage spaces 654S and 754S.

FIG. 10 is a side view showing a second modification of the holding portion for the wiring member 40.

The holding portion according to the second modification includes a storage space forming portion 654 that forms a storage space 654S in the base 32. Here, the storage space forming portion 654 includes a side wall 655 protruding from the first planar part 33 and an elastic clamping piece 657 protruding from the tip of the side wall 655 toward the first planar part 33. An opening through which the first wiring member 41 passes is formed between the tip of the elastic clamping piece 657 and the first planar part 33. The elastic clamping piece 657 is elastically deformable so as to widen the opening when pushed by the first wiring member 41. When the first wiring member 41 passes through the opening and is stored in the storage space 554S, the elastic clamping piece 657 elastically returns to its original position and presses the first wiring member 41 toward the first planar part 33. Thus, the first wiring member 41 is maintained in a state of being stored in the storage space 654S.

FIG. 11 is a side view showing a third modification of the holding portion for the wiring member 40.

The holding portion according to the third modification includes a storage space forming portion 754 that forms a storage space 754S in a base 732. Here, the storage space 754S is a groove formed in the first planar part 33. Instead of a groove being formed in the base, a storage space forming portion that forms the groove may be provided on the first planar part 33.

The storage space forming portion 754 includes a wall portion 755 that forms the bottom and side surfaces of the groove, and a lid 758 that covers the upper part of the groove. After the first wiring member 41 is stored in the groove, the lid 758 is maintained in a state of covering the upper part of the groove. With the upper part of the groove open, the first wiring member 41 is placed in the groove through the upper opening. Once the first wiring member 41 is placed in the groove, the lid 758 is closed to maintain the first wiring member 41 in a state of being stored in the storage space 554S.

One end of the lid 758 is fixed to part of the first planar part 33 on one side of the groove, and the other end of the lid 758 is fixed to part of the first planar part 33 on the other side of the groove. The fixing structure between the lid 758 and the first planar part 33 is not particularly limited and can be set as appropriate. The lid 758 may be fused or bonded to the first planar part 33, or a locking structure may be provided between the lid 758 and the first planar part 33. In the example shown in FIG. 11, a lid holding portion 759 is provided. With the lid holding portion 759, one end of the lid 758 is attached and fixed to the first planar part 33 by adhesive tape. In a state in which the other end of the lid 758 is not fixed to the first planar part 33, the lid 758 can be opened and closed using the lid holding portion 759 as a hinge.

The structures described in the above embodiments and modifications may be combined as appropriate as long as they are not mutually inconsistent.

### LIST OF REFERENCE NUMERALS

10 Seat
11 Framework
12 Lower frame
13 Upper frame
13L Left frame part
13R Right frame part
14, 314 Routing target member (connecting frame part)
15 First surface
16 Second surface
17, 317 Through hole
18 Cushion portion
20 Routing structure
30, 130 Wire harness
32, 132, 232, 332, 732 Base
33, 133 First planar part
33A, 133A First inner surface
33B, 133B First outer surface
34, 134 Second planar part
34A Second inner surface
34B Second outer surface
35, 135 Connecting part
36 Hinge-shaped portion
37 Tie insertion hole
40 Wiring member
41 First wiring member
42 Second wiring member
43 First connector
44 Second connector
45 Trunk portion
46 Branch portion
47 Adhesive tape
50 Cable tie
51 Band portion
52 Band fixing portion
60, 260, 360, 460 Fixing portion
61 Clip
62 Locking portion
63 Pillar portion
64 Plate portion
132A Rigid plate material
132B Flexible sheet
237 Fixing piece
238, 338 Locking hole
465 Bonding portion
554, 654, 754 Storage space forming portion
554S, 654S, 754S Storage space
555A Bottom wall
555B, 655 Side wall
556 Elastic retaining piece
657 Elastic clamping piece
755 Wall portion
758 Lid
759 Lid holding portion

1. A wire harness routing structure for a plate-like routing target member that includes a first surface and a second surface, the wire harness routing structure comprising:
a wire harness including a base and a wiring member routed to the base; and
a fixing portion configured to fix the base to the routing target member,
wherein the base includes a first planar part configured to cover the first surface, a second planar part configured to cover the second surface, and a connecting part configured to connect the first planar part and the second planar part to be bendable relative to each other on one side of the routing target member, and
the wiring member includes a first wiring member held by the first planar part and a second wiring member held by the second planar part.

2. The wire harness routing structure according to claim 1, wherein both the first planar part and the second planar part have a rigidity that makes the first planar part and the second planar part more difficult to bend than the connecting part.

3. The wire harness routing structure according to claim 2, wherein the base is a single rigid plate material from the first planar part to the second planar part, and
the connecting part has a hinge shape that is easier to bend than the first planar part and the second planar part.

4. The wire harness routing structure according to claim 1, wherein one of the first planar part and the second planar part has a rigidity that makes the planar part more difficult to bend than the connecting part.

5. The wire harness routing structure according to claim 1, wherein the fixing portion is configured to fix each of the first planar part and the second planar part to the routing target member.,

6. The wire harness routing structure according to claim 1 wherein the fixing portion is configured to fix the first planar part and the second planar part on an opposite side to the connecting part.

7. The wire harness routing structure according to claim 1, wherein the first wiring member extends to pass through the base, and
an end of the second wiring member is located on the base.

8. The wire harness routing structure according to claim 1, wherein the wire harness includes a branch portion that branches from a trunk portion into the first wiring member and the second wiring member, and
a distance between the base and the branch portion is shorter than a length of the first wiring member extending on the first planar part.

9. The wire harness routing structure according to claim 1, wherein the routing target member is a part of a framework of a seat of a vehicle.

10. A wire harness configured to be routed to a plate-like routing target member that includes a first surface and a second surface, the wire harness comprising:
a base including a first planar part configured to cover the first surface, a second planar part configured to cover the second surface, and a connecting part configured to connect the first planar part and the second planar part to be bendable relative to each other; and
a wiring member including a first wiring member held by the first planar part and a second wiring member held by the second planar part.
